(19) United States
(12) Patent Application Publication
(10) Pub. No.: US 2010/0302393 A1
(43) Pub. Date: Dec. 2, 2010

(54) SELF-PORTRAIT ASSISTANCE IN IMAGE CAPTURING DEVICES

(75) Inventors: Stefan Olsson, Lund (SE); Ola Karl Thorn, Malmo (SE); Maycel Isaac, Lund (SE)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/471,610

(22) Filed: May 26, 2009

(51) Int. Cl. H04N 5/228; G06K 9/00

(52) U.S. Cl. 348/222.1; 382/118; 348/E05.031

(57) ABSTRACT

A method may include determining whether an image area of an image capture device includes an image associated with a user/owner of the image capture device. Self-portrait optimization processing is performed when the image area includes an image associated with a user/owner. An image is captured based on the self-portrait optimization processing.

### BACKGROUND

Many of today's camera devices have the ability to aid a photographer in focusing, white balancing, and/or adjusting shutter speed. For focusing, a camera may use ultrasound or infrared sensors to measure the distance between a subject and the camera. For white balancing, the camera may digitally modify a color component of a picture to improve its quality. For adjusting shutter speed, the camera may determine the optimal exposure of photoelectric sensors to light within the camera. Unfortunately, existing camera devices do not assist users in correcting many types of photographic problems.

### SUMMARY

According to one aspect, a method may include determining whether an image area of an image capture device includes an image associated with a user/owner of the image capture device; performing self-portrait optimization processing when the image area includes an image associated with a user/owner; and capturing an image based on the self-portrait optimization processing.

Additionally, determining whether an image area of an image capture device includes an image associated with a user/owner of the image capture device, may include determining whether the image area includes a face; performing facial recognition when the image area includes a face; and determining whether the face is the user/owner based on the facial recognition.

Additionally, performing facial recognition, may include extracting identification information from the face; and comparing the extracted information to stored identification information associated with the user/owner.

Additionally, performing self-portrait optimization processing may include identifying optimal self-portrait conditions; and automatically initiating the image capturing based on the identified optimal self-portrait conditions.

Additionally, identifying optimal self-portrait conditions may include identifying at least one of: optimal image framing conditions, optimal lighting conditions, optimal motion conditions, or optimal focus conditions.

Additionally, performing self-portrait optimization processing may include identifying optimal self-portrait conditions; and providing a notification to the user based on the identified optimal self-portrait conditions.

Additionally, providing the notification may include providing an audible or visual alert to the user at a time of optimal self-portrait capture.

Additionally, the method may include receiving a user command to initiate image capturing based on the notification.

Additionally, performing self-portrait optimization processing may include modifying an input element associated with the image capture device to facilitate self-portrait capture; and receiving a user command to initiate image capturing via a modified input element.

Additionally, the modified input element comprises at least one of: a control key, a soft-key, a keypad, a touch screen display.

Additionally, modifying the input element changes a function normally associated with the input element into an image capture initiation function.

Additionally, the image capturing device may include a camera or mobile telephone.

According to another aspect, a device may include an image capturing assembly to frame an image for capturing; a viewfinder/display for outputting the framed image to the user prior to capturing; an input element to receive user commands; and a processor to: determine whether the framed image includes an image associated with a user/owner of the image capture device; perform self-portrait optimization processing when the framed image includes an image associated with a user/owner; and capture an image based on the self-portrait optimization processing.

Additionally, the processor to determine whether the framed image includes the image associated with a user/owner may be further configured to determine whether the image area includes a face; perform facial recognition when the image area includes a face; and determine whether the face is the user/owner based on the facial recognition.

Additionally, the processor to perform self-portrait optimization processing may be further configured to identify optimal self-portrait conditions; and automatically initiate the image capturing based on the identified optimal self-portrait conditions.

Additionally, the processor to identify optimal self-portrait conditions may be further configured to identify at least one of: optimal image framing conditions, optimal lighting conditions, optimal motion conditions, or optimal focus conditions.

Additionally, the device may include a notification element to output an audible or visual alert to the user, wherein the processor to perform self-portrait optimization processing may be further configured to identify optimal self-portrait conditions; and provide a notification to the user via the notification element based on the identified optimal self-portrait conditions.

Additionally, the processor to perform self-portrait optimization processing may be further configured to: modify a function associated with the input element to facilitate self-portrait capture; and receive a user command to initiate image capturing via a modified input element.

Additionally, the modified input element may include at least one of: a control key, a soft-key, a keypad, a touch screen display.

According to yet another aspect, a computer-readable medium having stored thereon a plurality of sequences of instructions is provided, which, when executed by at least one processor, cause the at least one processor to determine whether an image framed by an image capture device includes an image associated with a user/owner of the image capture device; perform self-portrait optimization processing when the framed image includes an image associated with a user/owner; and capture the image based on the self-portrait optimization processing.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 illustrates an exemplary viewfinder/display of an exemplary device in which concepts described herein may be implemented;

FIGS. 2A and 2B are front and rear views, respectively, of an exemplary device in which concepts described herein may be implemented;

FIGS. 3A and 3B are front and rear views, respectively, of another exemplary device in which concepts described herein may be implemented;

FIG. 4 is a block diagram of exemplary components of the exemplary device of FIGS. 2A, 2B, 3A, and 3B;

FIG. 5 is a functional block diagram of the exemplary device of FIGS. 2A and 2B;

FIGS. 6-10 are flowcharts of an exemplary process for performing self-portrait optimization.

### DETAILED DESCRIPTION OF EMBODIMENTS

The following detailed description refers to the accompanying drawings. The same reference numbers in different drawings may identify the same or similar elements.

In implementations described herein, a device (e.g., a still camera, a video camera, a mobile telephone, etc.) may aid a user in taking pictures. In particular, the device may, using a variety of techniques, identify an owner or user associated with the device in an image capture area of the device when the device is in an image capture mode. The device may, once the user is identified, determine that the user wishes to take a self-portrait and may take actions to assist the user in taking the self-portrait. For example, in one implementation, input controls associated with the device may be modified to facilitate user activation of an image capture. In additional implementations, processing may be performed to identify an optimal image capture opportunity, such as, in image framing or composition, lighting, motion of the image subject or device, focus characteristics, etc. The device may provide an audio or visual notification to the user indicating the identified optimal image capture opportunity, or alternatively, may automatically capture an image when the optimal image capture opportunity has been identified.

For example, assume that a user wishes to take a self-portrait in a scenic location. Typical camera devices include a viewfinder or display on a side of the device opposite from a lens assembly used to capture an image. Accordingly, in preparing to take a self-portrait, the user may invert the camera device so as to present themselves in front of the lens assembly. Unfortunately, this typically renders the viewfinder or image display not viewable by the user. In addition, some camera devices include actuator elements that are not visible or easily reachable or ascertainable from an inverted position. For example, modern mobile telephone devices that include cameras may not include traditional shutter buttons accessible from a side or top of the device. Rather, camera applications on such devices may include soft-keys or touch screen elements for activating an image or video capture.

Consistent with embodiments described herein, the device may dynamically analyze, prior to capturing of the image, the framed image area to be captured, and may determine whether the image area includes the user or owner of the device. In the event that the user is identified, various steps may be taken improve the user's ability to take a satisfactory self-portrait.

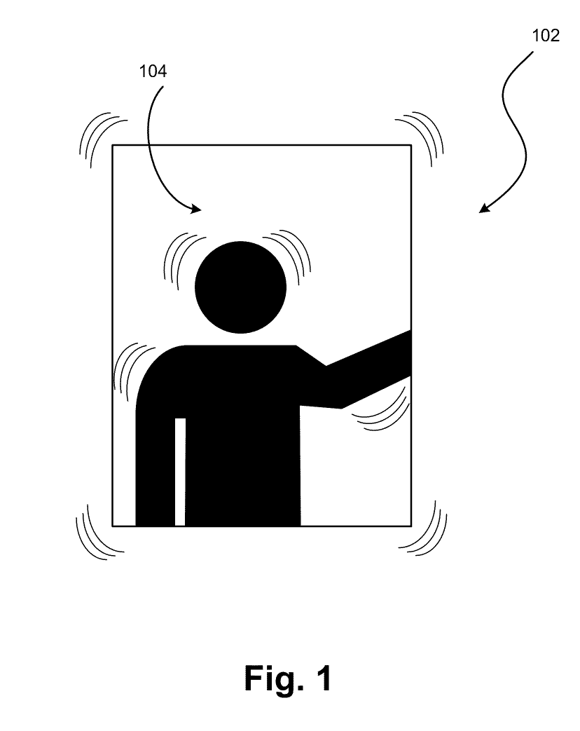

FIG. 1 illustrates an exemplary viewfinder/display of an exemplary device in which concepts described herein may be implemented. FIG. 1A shows a viewfinder/display 102 with a subject image 104. As briefly described above, when taking a self-portrait, both the subject of subject image 104 and the camera itself may be moving in a manner unknown by the user, since the user is not viewing viewfinder/display 102. This movement is illustrating by motion lines at various places in FIG. 1.

Consistent with embodiments described herein, the camera may dynamically determine that subject image 104 is a self-portrait in that it includes an owner or user associated with the camera. Once it has been determined that subject image 104 includes the owner or user (e.g., via facial recognition techniques, etc.), the camera may facilitate capturing of the user's self-portrait. For example, as described above, the camera may modify control elements to make it easier for the user to initiate an image capture without seeing a device interface. Alternatively, the camera may automatically capture an optimal self-portrait (e.g., centered or framed in the viewfinder, in focus, well-lit, etc.). In yet another implementation, the camera may alert the user to optimal image capture conditions. The user may initiate an image capture based on the alert.

The term “image,” as used herein, may refer to a digital or an analog representation of visual information (e.g., a picture, a video, a photograph, animations, etc). The term “camera,” as used herein, may include a device that may capture images. For example, a digital camera may include an electronic device that may capture and store images electronically instead of using photographic film. A digital camera may be multifunctional, with some devices capable of recording sound and/or images. Other exemplary image capture devices may include mobile telephones, video cameras, camcorders, global positioning system (GPS) devices, portable gaming or media devices, etc. A “subject,” as the term is used herein, is to be broadly interpreted to include any person, place, and/or thing capable of being captured as an image. The term “subject image” may refer to an image of a subject. The term “frame” may refer to a closed, often rectangular, border of lines or edges (physical or logical) that enclose the picture of a subject.

### Exemplary Device

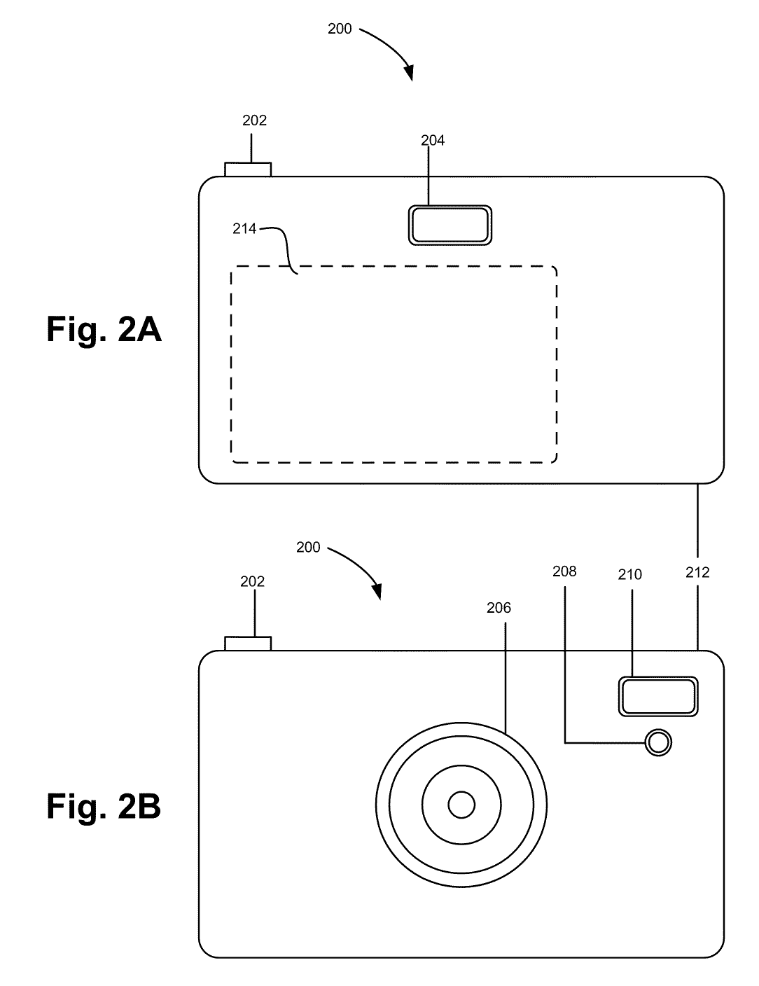

FIGS. 2A and 2B are front and rear views, respectively, of an exemplary device 200 in which concepts described herein may be implemented. In this implementation, device 200 may take the form of a camera (e.g., a standard 35 mm or digital camera). As shown in FIGS. 2A and 2B, device 200 may include a button 202, viewfinder/display 204, lens assembly 206, notification element 208, flash 210, housing 212, and display 214. Button 202 may permit the user to interact with device 200 to cause device 200 to perform one or more operations, such as taking a picture. Viewfinder/display 204 may provide visual information to the user, such as an image of a view, video images, pictures, etc. Lens assembly 206 may include an image capturing assembly for manipulating light rays from a given or a selected range, so that images in the range can be captured in a desired manner.

Notification element 208 may provide visual or audio information regarding device 200. For example, notification element 208 may include a light emitting diode (LED) configured to illuminate or blink upon determination of optimal self-portrait conditions, as will be described in additional detail below. Output of notification element 208 may be used to aid the user in capturing self-portrait images.

Flash 210 may include any type of flash unit used in cameras and may provide illumination for taking pictures. Housing 212 may provide a casing for components of device 200 and may protect the components from outside elements. Display 214 may provide a larger visual area for presenting the contents of viewfinder/display 204 as well as providing visual feedback regarding previously captured images or other information. Further, display 214 may include a touch screen display configured to receive input from a user. In some implementations, device 200 may include only display 214 and may not include viewfinder/display 204. Depending on the particular implementation, device 200 may include fewer, additional, or different components than those illustrated in FIGS. 2A and 2B.

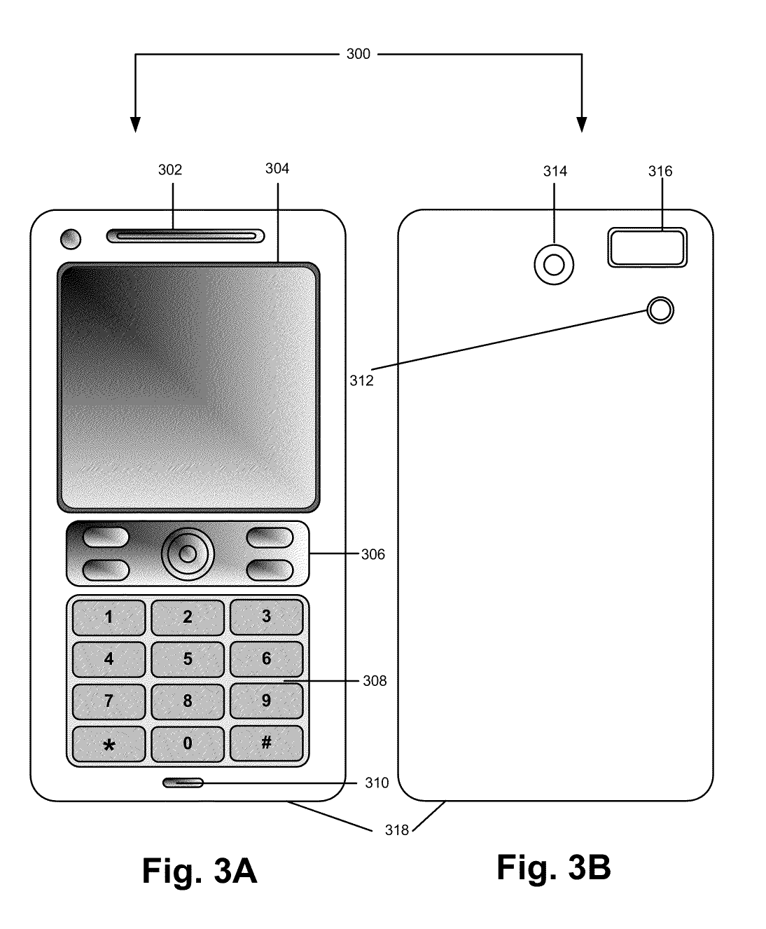

FIGS. 3A and 3B are front and rear views, respectively, of another exemplary device 300 in which concepts described herein may be implemented. In the implementation shown, device 300 may include any of the following devices that have the ability to or are adapted to capture or process images (e.g., a video clip, a photograph, etc): a telephone, such as a radio telephone or a mobile telephone; a personal communications system (PCS) terminal that may combine a cellular radiotelephone with, data processing, facsimile, and/or data communications capabilities; an electronic notepad; a laptop; a personal computer (PC); a personal digital assistant (PDA) that can include a telephone; a video camera; a web-enabled camera or webcam; a global positioning system (GPS) navigation device; a portable gaming device; a videoconferencing system device; or another type of computational or communication device with the ability to process images.

As shown, device 300 may include a speaker 302, a display 304, control buttons 306, a keypad 308, a microphone 310, a LED 312, a lens assembly 314, a flash 316, and housing 318. Speaker 302 may provide audible information to a user of device 300. Display 304 may provide visual information to the user, such as video images or pictures. Control buttons 306 may permit the user to interact with device 300 to cause device 300 to perform one or more operations, such as place or receive a telephone call. Keypad 308 may include a standard telephone keypad. Microphone 310 may receive audible information from the user. LED 312 may provide visual notifications to the user. Lens assembly 314 may include a device for manipulating light rays from a given or a selected range, so that images in the range can be captured in a desired manner. Flash 316 may include any type of flash unit used in cameras and may provide illumination for taking pictures. Housing 318 may provide a casing for components of device 300 and may protect the components from outside elements.

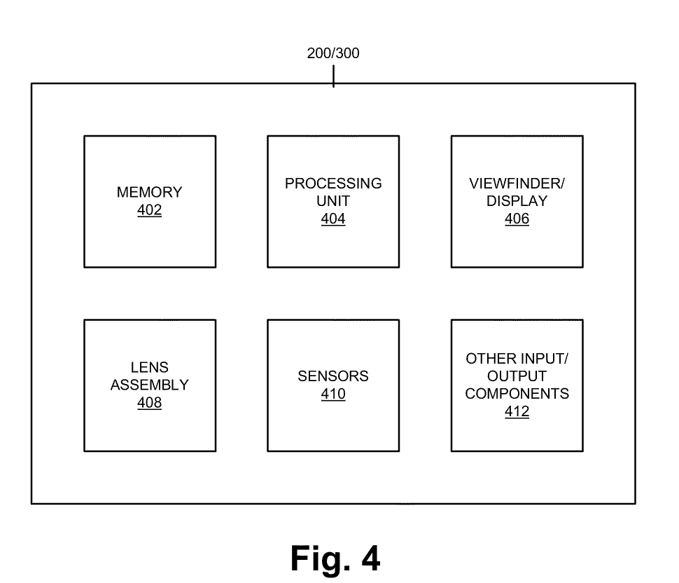

FIG. 4 is a block diagram of exemplary components of device 200/300. The term “component,” as used herein, may refer to hardware component, a software component, or a combination of the two. As shown, device 200/300 may include a memory 402, a processing unit 404, a viewfinder/display 406, a lens assembly 408, sensors 410, and other input/output components 412. In other implementations, device 200/300 may include more, fewer, or different components.

Memory 402 may include static memory, such as read only memory (ROM), and/or dynamic memory, such as random access memory (RAM), or onboard cache, for storing data and machine-readable instructions. Memory 402 may also include storage devices, such as a floppy disk, CD ROM, CD read/write (R/W) disc, and/or flash memory, as well as other types of storage devices. Processing unit 404 may include a processor, a microprocessor, an Application Specific Integrated Circuit (ASIC), a Field Programmable Gate Array (FPGA), and/or other processing logic capable of controlling device 200/300.

Viewfinder/display 406 may include a component that can display signals generated by device 200/300 as images on a screen and/or that can accept inputs in the form of taps or touches on the screen. For example, viewfinder/display 406 may provide a window through which the user may view images that are received from lens assembly 408. Examples of viewfinder/display 406 include an optical viewfinder (e.g., a reversed telescope), liquid crystal display (LCD), organic light-emitting diode (OLED) display, surface-conduction electron-emitter display (SED), plasma display, field emission display (FED), bistable display, and/or a touch screen. In an alternative implementation, device 200/300 may include display 214 for enabling users to preview images that are received from lens assembly 408 prior to capturing. Subsequent to image capturing, display 214 may allow for review of the captured image.

Lens assembly 408 may include a component for manipulating light rays from a given or a selected range, so that images in the range can be captured in a desired manner (e.g., a zoom lens, a wide-angle lens, etc.). Lens assembly 408 may be controlled manually and/or electromechanically by processing unit 404 to obtain the correct focus, span, and magnification (i.e., zoom) of the subject image and to provide a proper exposure.

Sensors 410 may include one or more devices for obtaining information related to image, luminance, focus, zoom, sound, distance, movement of device 200/300, and/or orientation of device 200/300. Sensors 410 may provide the information to processing unit 404, so that processing unit 404 may control lens assembly 408 and/or other components that together form an image capturing assembly. Examples of sensors 410 may include a complementary metal-oxide-semiconductor (CMOS) sensor and/or charge-coupled device (CCD) sensor for sensing light, a gyroscope for sensing the orientation of device 200/300, an accelerometer for sensing movement of device 200/300, an infrared signal sensor or an ultrasound sensor for measuring a distance from a subject to device 200/300, a microphone, etc. Other input/output components 412 may include components for converting physical events or phenomena to and/or from digital signals that pertain to device 200/300. Examples of other input/output components 412 may include a flash, button(s), mouse, speaker, microphone, Universal Serial Bus (USB) port, IEEE 1394 (e.g., Firewire®) interface, etc. Notification element 208 may be an input/output component 412 and may include a speaker, a light (e.g., an LED), etc.

In other implementations, device 200/300 may include other components, such as a network interface. If included in device 200/300, the network interface may include any transceiver-like mechanism that enables device 200/300 to communicate with other devices and/or systems. For example, the network interface may include mechanisms for communicating via a network, such as the Internet, a terrestrial wireless network (e.g., wireless local area network (WLAN)), a satellite-based network, etc. Additionally or alternatively, the network interface may include a modem, an Ethernet interface to a local area network (LAN), and/or an interface/connection for connecting device 200/300 to other devices (e.g., a Bluetooth interface).

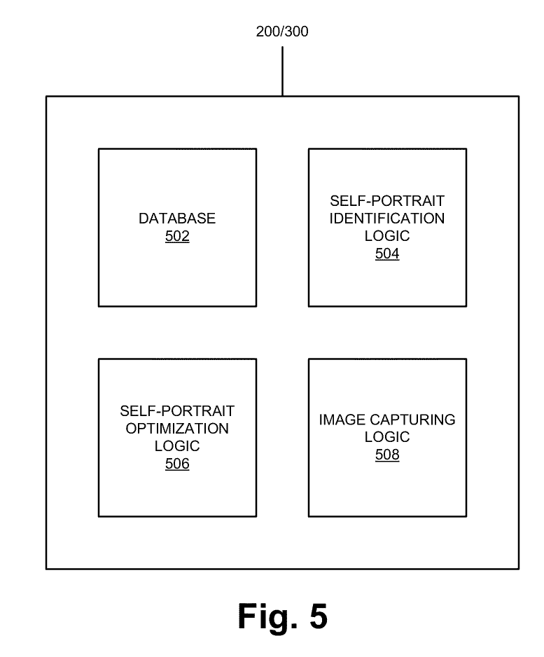

FIG. 5 is a functional block diagram of device 200/300. As shown, device 200/300 may include a database 502, self-portrait identification logic 504, self-portrait optimization logic 506, and/or image capturing logic 508. Depending on the particular implementation, device 200/300 may include fewer, additional, or different types of functional blocks than those illustrated in FIG. 5.

Database 502 may be included in memory 402 (FIG. 4) and act as an information repository for the components of device 200/300. For example, in one implementation, database 402 may store or maintain images (e.g., pictures, video clips, etc.) that may be stored and/or accessed by self-portrait optimization logic 506, image capture logic 508, and/or self-portrait identification logic 504. For example, database 502 may include one or more images associated with the owner or user of device 200/300. Alternatively, database 502 may include information, such as a mapping, relating to the user or owner. For example, one or more images associated with the owner/user may be mapped for face data, such as relative positioning and sizes of facial features such as eyes, cheekbones, lips, nose, jaw, etc. In another alternative, database 502 may include other biometric information corresponding to the user/owner of device 200/300 such as retinal data, skin texture data, etc. In other implementations, images associated with the user/owner may include biometric information, such as an item associated with the user (e.g., eyeglasses, an automobile, or some other article). This information (i.e., the face or other biometric data) may be stored in database 502 for comparison to subject images presented to lens assembly 408.

Self-portrait identification logic 504 may include hardware and/or software for determining that the user intends to take a self-portrait. In one implementation, this determination is made by comparing a subject image presented to lens assembly 408 (e.g., prior to image capture) to the image or face data in database 502 that is associated with a particular user or owner of device 200/300. For example, self-portrait identification logic 504 may analyze the subject image and may extract face data for any faces identified in the subject image. In other implementations, self-portrait identification logic 504 may analyze the subject image for other non-face or biometric articles associated with owner/user. Self-portrait identification logic 504 may compare the extracted face data against the face data corresponding to the owner of device 200/300. For example, assume that self-portrait identification logic 504 generates one or more values based on the corresponding face data elements extracted from the subject image. When each of the values substantially match face data element values corresponding to the user/owner image, a face in the subject image may be considered a match to the face in the user/owner image. Such processing may generally be referred to as “facial recognition.”

Self-portrait optimization logic 506 may include hardware and/or software for facilitating optimal self-portrait capturing by device 200/300. In one implementation, self-portrait optimization logic 506 may be configured to analyze the subject area and to automatically initiate image capturing by image capturing logic 508, upon identification of optimal self-portrait conditions when it is determined that the image area includes the user/owner of device 200/300. Such conditions may include image framing conditions, such as centering the user in the subject area of device 200/300, lighting conditions, motion conditions, focus conditions, etc. In one exemplary implementation, self-portrait optimization logic 506 may determine whether the subject area includes more than one face. If so, self-portrait optimization logic 506 may initiate image capture when all faces are framed within the subject area.

In another implementation consistent with embodiments described herein, self-portrait optimization logic 506 may be configured to alert the user to the identified optimal self-portrait conditions. For example, notification element 208 may include an LED (e.g., LED 312). Self-portrait optimization logic 506 may be configured to analyze the subject area and to illuminate LED 208/312 upon identification of optimal self-portrait conditions. Illumination of LED 208/312 may notify the user of the optimal image capture conditions without the user needing to preview the image area.

In still another implementation, self-portrait optimization logic 506 may be configured to modify functions associated with input controls, e.g., control keys 306 and/or display (e.g., touch screen display) 304 upon identification of a self-portrait attempt by self-portrait identification logic 504. For example, assume that one or more of control keys 306 or portions of display 304 is not associated with image capture functions (e.g., zoom level, brightness, flash type, etc.) when self-portrait identification logic 504 does not identify a self-portrait attempt.

When self-portrait identification logic 504 identifies a self-portrait attempt, however, self-portrait optimization logic 406 may modify the functions associated with keys 306/308 and/or display 304 to facilitate taking an optimal self-portrait. For example, self-portrait optimization logic 406 may modify the functions of keys 306/308 and/or display 304, such that selection of any of keys 306/308 and/or display initiates image capture by image capturing logic 508.

In one implementation, identification of a self-portrait attempt by self-portrait identification logic 504 may trigger of a mode switch in device 200 to activate a “blind” user interface (ui). The blind ui may make it easier to take a self-portrait by, for example, modifying size, location, or number of keys associated with an image capture button on touch screen display 304 or control keys 306. In alternative implementations, recognition of a user may also trigger deactivation of backlighting or other illumination of display 304 (or control keys 306/keypad 308) to save battery life.

Image capturing logic 508 may include hardware and/or software for capturing the subject image at a point in time requested by the user or initiated by self-portrait optimization logic 506. For example, image capturing logic 508 may capture and store (e.g., in database 502) the subject image visible via lens assembly 408 when the user depresses button 202 or, as described above, upon selection of any of keys 306/308 and/or touch screen display 304. Alternatively, image capturing logic 508 may capture and store (e.g., in database 502) the subject image visible via lens assembly 408 at an optimal time identified by self-portrait optimization logic 506.

### Exemplary Processes for Self-Portrait Optimization

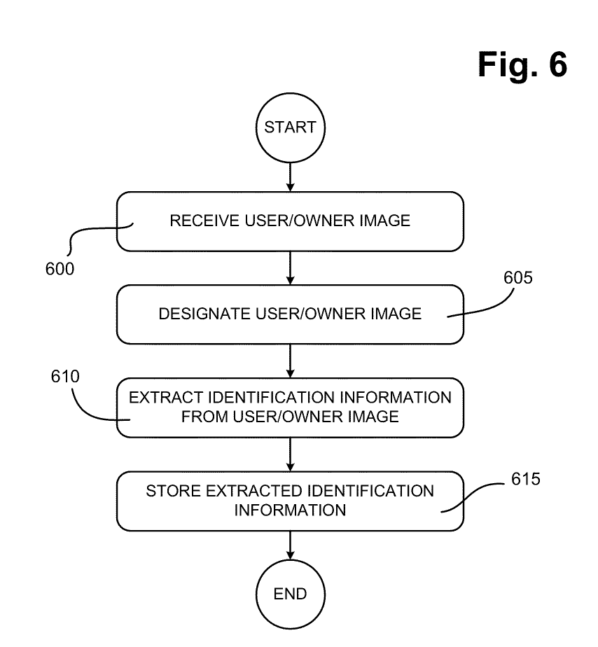

FIGS. 6-10 are flow charts illustrating exemplary processes for self-portrait optimization in a camera device, such as device 200/300. In some implementations, the processes of FIGS. 6-10 may be performed by self-portrait identification logic 504 and self-portrait optimizing logic 506. In such instances, some or all of the processes of FIGS. 6-10 may be performed by one or more components of device 200/300, such as, for example, processing unit 404.

As illustrated in FIG. 6, processing may begin with device 200/300 receiving a user/owner image associated with a user or owner device 200/30 (block 600). For example, the user/owner image may be captured via image capturing logic 508. In another implementation, the user/owner image may be received in other ways, such as on a memory card or via an electrically connected device. In some implementations more than one user/owner image may be obtained. As described above, the image associated with the user/owner may include facial information, other biometric information, or non-biometric information, such as an image of an article associated with the user/owner.

Once obtained, the user/owner image may be designated as the user/owner image in device 200/300 (block 605). For example, a setting available in a menu of device 200/300 may enable the user to designate a user/owner image. Device 200/300 may extract identification information from the user/owner image (block 610). For example, face data may be extracted from the user/owner image. Alternatively, other identification information may be determined from the user/owner image. The extracted identification information may be stored for later use in performing self-portrait optimization (block 615).

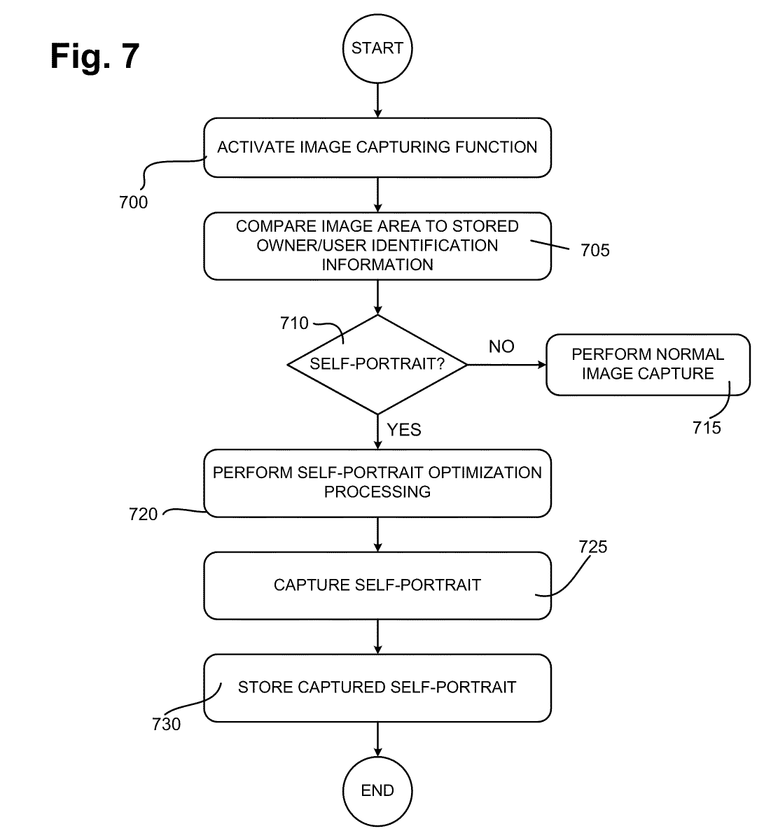

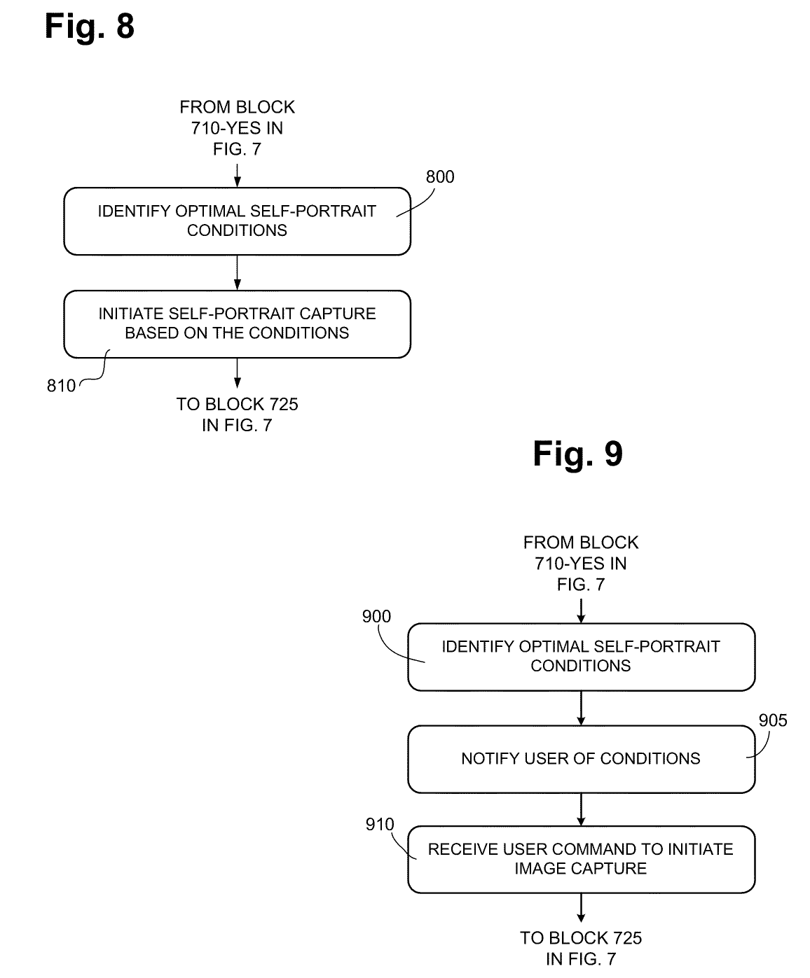

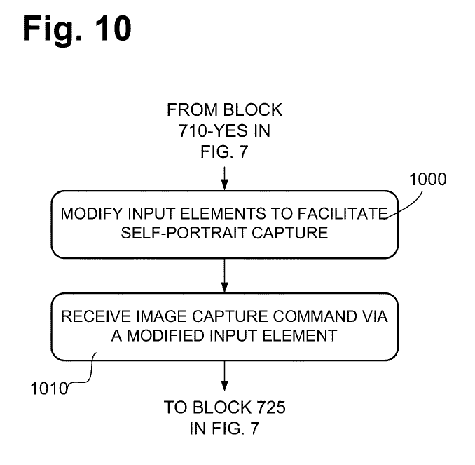

Turning to FIG. 7, processing may begin upon an image capturing function or application of device 200/300 becoming activated or powered on (block 700). In an alternative embodiment, processing may begin upon determination that a user is likely to capture an image. For example, factors such as how much device 200/300 is shaking or moving, the orientation of device 200/300, the amount of light that is detected by device 200/300, a detection of a subject image within a frame, etc., may be used to determine that the user is likely to capture an image. By restricting processing to instances where image capturing is likely, unnecessary image analysis and processing may be reduced or eliminated, thereby reducing unnecessary power consumption.

Self-portrait identification logic 504 may compare an image area presented to lens assembly 508 to the stored user/owner identification information (block 705). In one implementation, self-portrait identification logic 504 may initially determine whether the image area includes any faces and, if so, may extract identification from the faces and may compare the extracted identification information to the stored user/owner identification information.

Self-portrait identification logic 504 may determine whether the user is attempting to take a self-portrait based on the comparison (block 710). If not (block 710—NO), normal image capture processing may continue (block 715). However, if self-portrait identification logic 504 determines that the user is attempting to take a self-portrait (block 710—YES), self-portrait optimization logic 506 may perform self-portrait optimization processing (block 720).

Image capturing logic 408 may capture a self-portrait based on the self-portrait optimization processing (block 725). For example, image capturing logic 408 may be initiated by self-portrait optimization logic 506 or by user interaction with control elements, such as button 202, keys/keypad 306/308, or display 304. The captured image may be stored, e.g., in database 502 (block 730).

FIG. 8 is flow chart of exemplary processing associated with block 720 of FIG. 7. Self-portrait optimization logic 506 may identify optimal self-portrait conditions (block 800). For example, self-portrait optimization logic 506 may analyze the subject area for various conditions, such as framing conditions, lighting conditions, focus, zoom level, motion, etc. Self-portrait optimization logic 506 may then initiate image capture by image capture logic 508, at a time corresponding to the identified optimal self-portrait conditions (block 805).

FIG. 9 is a flow chart of another exemplary processing associated with block 720 of FIG. 7. Self-portrait optimization logic 506 may identify optimal self-portrait conditions (block 900). For example, self-portrait optimization logic 506 may analyze the subject area for various conditions, such as framing conditions, lighting conditions, focus, zoom level, motion, etc. Self-portrait optimization logic 506 may then notify the user at a time corresponding to the identified optimal self-portrait conditions (block 905). For example, self-portrait optimization logic 506 may output a visual and/or audible notification via notification element 208/LED 312. Image capture logic 508 may receive a command from the user to initiate image capture (block 910). For example, the user may depress button 202 of device 200.

FIG. 10 is a flow chart of yet another exemplary processing associated with block 720 of FIG. 7. In this embodiment, self-portrait optimization logic 506 may modify one or more input elements to facilitate satisfactory self-portrait capture (block 1000). For example, self-portrait optimization logic 506 may modify one or more of control keys 306, keypad 308, or touch screen display 304 in a manner that facilitates self-portrait capture, such as activating the elements initiate image capture functions rather than functions normally associated with the input elements, such as zoom level adjustment, brightness adjustment, etc.

In one implementation, modification of the one or more input elements may include triggering of a mode switch in device 200 that enhances the user interface of device 100, thereby making it easier to take a self-portrait. For example, a layout of image capture controls on touch screen display 304 or control keys 306 may be modified to, for example, increase a size, location, or number of keys associated with an image capture button. In alternative implementations, recognition of a user may trigger deactivation of backlighting or other illumination of display 304 (or control keys 306/keypad 308) to save battery life, since block 720 has determined that the user is not facing display 304.

Image capture logic 508 may subsequently receive a command from the user to initiate image capture via one of the modified input elements (block 1010). For example, the user may depress a control key 306, or any portion of touch screen 304.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary processes illustrated in FIGS. 6-10, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
determining whether an image area of an image capture device includes an image associated with a user/owner of the image capture device;
performing self-portrait optimization processing when the image area includes an image associated with the user/owner; and
capturing the image based on the self-portrait optimization processing.

2. The method of claim 1, wherein determining whether an image area of an image capture device includes an image associated with a user/owner of the image capture device further comprises:
determining whether the image area includes a face;
performing facial recognition when the image area includes a face; and
determining whether the face is a face of the user/owner based on the facial recognition.

3. The method of claim 2, wherein performing facial recognition further comprises:
extracting identification information from the face; and
comparing the extracted information to stored identification information associated with the user/owner.

4. The method of claim 1, wherein performing self-portrait optimization processing further comprises:
identifying optimal self-portrait conditions; and
automatically initiating the image capturing based on the identified optimal self-portrait conditions.

5. The method of claim 4, wherein identifying optimal self-portrait conditions further comprises:
identifying at least one of: optimal image framing conditions, optimal lighting conditions, optimal motion conditions, or optimal focus conditions.

6. The method of claim 1, wherein performing self-portrait optimization processing further comprises:
identifying optimal self-portrait conditions; and
providing a notification to the user based on the identified optimal self-portrait conditions.

7. The method of claim 6, wherein providing a notification further comprises providing an audible or visual alert to the user at a time of optimal self-portrait capture.

8. The method of claim 6, further comprising:
receiving a user command to initiate image capturing based on the notification.

9. The method of claim 1, wherein performing self-portrait optimization processing, further comprises:
modifying an input element associated with the image capture device to facilitate self-portrait capture; and
receiving a user command to initiate image capturing via the modified input element.

10. The method of claim 9, wherein the modified input element comprises at least one of: a control key, a soft-key, a keypad, or a touch screen display.

11. The method of claim 9, wherein modifying the input element includes changing a function normally associated with the input element into an image capture initiation function.

12. The method of claim 1, wherein the image capturing device comprises a camera or mobile telephone.

13. A device comprising:
an image capturing assembly to frame an image for capturing;
a viewfinder/display for outputting the framed image to the user prior to capturing;
an input element to receive user commands; and
a processor to:
determine whether the framed image includes an image associated with a user/owner of the device;
perform self-portrait optimization processing when the framed image includes an image associated with the user/owner; and
capture the image based on the self-portrait optimization processing.

14. The device of claim 13, wherein the processor to determine whether the framed image includes an image associated with a user/owner is further configured to:
determine whether the framed image includes a face;
perform facial recognition when the framed image includes a face; and
determine whether the face is a face of the user/owner based on the facial recognition.

15. The device of claim 13, wherein the processor to perform self-portrait optimization processing is further configured to:
identify optimal self-portrait conditions; and
automatically initiate the image capturing based on the identified optimal self-portrait conditions.

16. The device of claim 15, wherein the processor to identify optimal self-portrait conditions is further configured to:
identify at least one of: optimal image framing conditions, optimal lighting conditions, optimal motion conditions, or optimal focus conditions.

17. The device of claim 13, further comprising:
a notification element to output an audible or visual alert to the user,
wherein the processor to perform self-portrait optimization processing is further configured to:
identify optimal self-portrait conditions; and
provide a notification to the user via the notification element based on the identified optimal self-portrait conditions.

18. The device of claim 13, wherein the processor to perform self-portrait optimization processing is further configured to:
modify a function associated with the input element to facilitate self-portrait capture; and
receive a user command to initiate image capturing via the modified input element.

19. The device of claim 18, wherein the modified input element comprises at least one of: a control key, a soft-key, a keypad, or a touch screen display.

20. A computer-readable medium having stored thereon a plurality of sequences of instructions which, when executed by at least one processor, cause the at least one processor to:
determine whether an image framed by an image capture device includes an image associated with a user/owner of the image capture device;
perform self-portrait optimization processing when the framed image includes an image associated with the user/owner; and
capture the image based on the self-portrait optimization processing.
